(19) United States
(12) Patent Application Publication
(10) Pub. No.: US 2014/0238147 A1
(43) Pub. Date: Aug. 28, 2014

(54) FUEL INSTRUMENT DETERMINATION DEVICE, FLOW METER DEVICE, GAS METER AND FUEL INSTRUMENT DETERMINATION METHOD

(71) Applicant: Panasonic Corporation, Kadoma-shi, Osaka (JP)

(72) Inventors: Mitsuo Yokohata, Osaka (JP); Motoyuki Nawa, Nara (JP)

(73) Assignee: Panasonic Corporation, Kadoma-shi, Osaka (JP)

(21) Appl. No.: 14/352,577

(22) PCT Filed: Oct. 17, 2012
(86) PCT No.: PCT/JP2012/006633

§ 371 Date: Apr. 17, 2014

(30) Foreign Application Priority Data
Oct. 18, 2011 (JP) 2011-228913

(51) Int. Cl. G01F 15/00

(52) U.S. Cl. CPC G01F 15/002
USPC 73/861

(57) ABSTRACT

A fuel instrument determination device comprises a first obtaining section for obtaining a slope of a change in a fuel flow rate in a first measurement period; a second obtaining section for obtaining a slope of a change in the fuel flow rate in a second measurement period which is different in length from the first measurement period; and a determiner section for determining a fuel instrument, using the slope of the change in the fuel flow rate in the first measurement period and the slope of the change in the fuel flow rate in the second measurement period.

### TECHNICAL FIELD

The present invention relates to a fuel instrument determination device and a fuel instrument determination method. More specifically, the present invention relates to a fuel instrument determination device and a fuel instrument determination method, which determine a fuel instrument by utilizing a slope of a change in a fuel flow rate.

### BACKGROUND ART

Patent Literature 1 discloses a gas meter device. The gas meter device includes a flow rate measurement means which is connected to a home gas supply pipe and measures a gas flow rate at constant time intervals, a calculator means which calculates a difference value between flow rate values output from the flow rate measurement means, and a comparator/determiner means which compares the difference value calculated by the calculator means to change point determination values stored in a storage means to determine a change in a use state of a particular gas instrument. The comparator/determiner means compares the difference value between the flow rate values to the change point determination values stored in the storage means such that the determination values correspond to gas instruments, respectively, thereby determining which of the gas instruments the change in the use state has occurred in (claim 3).
Patent Literature 1: Japanese Laid-Open Patent Application Publication No. 2006-313114

### SUMMARY OF THE INVENTION

### Technical Problem

An object of the present invention is to improve an accuracy of determination as to a fuel instrument, in a fuel instrument determination device and a fuel instrument determination method, which determine the fuel instrument by utilizing a slope of a change in a fuel flow rate.

### Solution to Problem

The inventors intensively studied to improve an accuracy of determination as to a fuel instrument, in a fuel instrument determination device and a fuel instrument determination method, which determine the fuel instrument by utilizing a slope of a change in a fuel flow rate, and discovered the following.

In a fuel instrument such as a stove burner, a fuel consumption amount changes relatively steeply with time, at the time of start of its operation, during the operation, and at the end of the operation. In contrast, in a fuel instrument such as a fuel cell system, a fuel consumption amount changes very gradually with time, at the time of start of its operation, during the operation, and at the end of the operation. In some cases, a conventional fuel instrument determination device cannot accurately determine start of the use of the fuel instrument in which the fuel consumption amount changes very gradually with time.

For example, if an attempt is made to determine the fuel instrument based on the slope of the change in the fuel flow rate for a short time (e.g., several seconds), the change in the fuel flow rate cannot be detected for the fuel instrument in which the fuel consumption amount changes very gradually with time, because its changing magnitude is small. Also, if an attempt is made to determine the fuel instrument based on the slope of the change in the fuel flow rate for a long time (e.g., several tens minutes), it is difficult to determine another fuel instrument which causes a great change in the fuel flow rate within a short time and the fuel instrument in which the fuel consumption amount changes very gradually with time such that these fuel instruments are distinguished from each other.

In view of the above described finding, the inventors conceived that an accuracy of determination as to the fuel instrument can be improved, by utilizing slopes of changes in fuel flow rates in two kinds of measurement periods which are different in length from each other, i.e., a first measurement period and a second measurement period.

A fuel instrument determination device of the present invention comprises: a first obtaining section for obtaining a slope of a change in a fuel flow rate in a first measurement period; a second obtaining section for obtaining a slope of a change in the fuel flow rate in a second measurement period which is different in length from the first measurement period; and a determiner section for determining a fuel instrument, using the slope of the change in the fuel flow rate in the first measurement period and the slope of the change in the fuel flow rate in the second measurement period.

In this configuration, an accuracy of determination as to the fuel instrument, can be improved in the fuel instrument determination device which determines the fuel instrument by utilizing the slope of the change in the fuel flow rate.

In the above fuel instrument determination device, the second measurement period may include a plurality of first measurement periods.

In the above fuel instrument determination device, the determiner section may be configured to determine the fuel instrument, using each of slopes of changes in fuel flow rates in the plurality of first measurement periods and the slope of the change in the fuel flow rate in the second measurement period.

In the above fuel instrument determination device, the second measurement period may be composed of the plurality of first measurement periods which are successive.

In the above fuel instrument determination device, the second obtaining section may be configured to perform calculation to obtain the slope of the change in the fuel flow rate in the second measurement period, using the slope of the change in the fuel flow rate in the first measurement period, which is obtained by the first obtaining section.

In the above fuel instrument determination device, the determiner section may be configured to determine the fuel instrument, depending on whether or not the slope of the change in the fuel flow rate in the first measurement period falls within a first range.

In the above fuel instrument determination device, the determiner section may be configured to determine the fuel instrument, depending on whether or not the slope of the change in the fuel flow rate in the second measurement period falls within a second range.

In the above fuel instrument determination device, the determiner section may be configured to determine the fuel instrument, depending on whether or not the slope of the change in the fuel flow rate in the first measurement period falls within a first range, and whether or not the slope of the change in the fuel flow rate in the second measurement period falls within a second range.

In the above fuel instrument determination device, the first range may include the second range.

The phrase, “the first range includes the second range” means that, for example, when a certain value falls within the second range, it falls within the first range without fail. More specifically, for example, when the first range is between m₁ and m₂ and the second range is between M₁ and M₂, “the first range includes the second range” means that m₁≦M₁≦M₂≦m₂ is satisfied. Or, when the first range is between m₁ and m₂ and the second range is between M₁ and M₂, “the first range includes the second range” may mean that M₁≦m₁<M₂≦m₂ is satisfied. Or, when the first range is between m₁ and m₂ and the second range is between M₁ and M₂, “the first range includes the second range” may mean that M₁≦m₁<m₂≦M₂ is satisfied. Or, when the first range is between m₁ and m₂ and the second range is between M₁ and M₂, “the first range includes the second range” may mean that m₁≦M₁<m₂≦M₂ is satisfied.

In the above fuel instrument determination device, the determiner section may be configured to determine the fuel instrument, depending on whether or not slopes of changes in fuel flow rates in all of the first measurement periods included in the second measurement period fall within the first range.

In the above fuel instrument determination device, the first measurement periods may be equal in length to each other.

The above fuel instrument determination device may comprise a flow rate obtaining section for obtaining a gas flow rate from a gas meter via a network; the first obtaining section may be configured to obtain a slope of a change in a gas fuel flow rate in the gas meter in the first measurement period; and the second obtaining section may be configured to obtain a slope of a change in the gas fuel flow rate in the gas meter in the second measurement period.

In the above fuel instrument determination device, the first obtaining section may be configured to obtain from a gas meter a slope of a change in a gas fuel flow rate in the gas meter in the first measurement period via a network; and the second obtaining section may be configured to perform calculation to obtain a slope of a change in the gas fuel flow rate in the gas meter in the second measurement period, using the slope of the change in the gas fuel flow rate in the gas meter in the first measurement period, which is obtained by the first obtaining section.

In the above fuel instrument determination device, the first obtaining section may be configured to obtain from a gas meter a slope of a change in a gas fuel flow rate in the gas meter in the first measurement period via a network; and the second obtaining section may be configured to obtain from the gas meter a slope of a change in the gas fuel flow rate in the gas meter in the second measurement period via the network.

A flow meter device of the present invention comprises a fluid passage: a flow rate measurement section for measuring a fuel flow rate of a fuel flowing through the fluid passage; a first obtaining section for obtaining a slope of a change in the fuel flow rate in a first measurement period; a second obtaining section for obtaining a slope of a change in the fuel flow rate in a second measurement period which is different in length from the first measurement period; and a determiner section for determining a fuel instrument which is connected to the fluid passage, using the slope of the change in the fuel flow rate in the first measurement period and the slope of the change in the fuel flow rate in the second measurement period.

A gas meter of the present invention comprises: a fluid passage: a flow rate measurement section for measuring a flow rate of a gas flowing through the fluid passage; a first obtaining section for obtaining a slope of a change in a gas fuel flow rate in a first measurement period; a second obtaining section for obtaining a slope of a change in the gas fuel flow rate in a second measurement period which is different in length from the first measurement period; and a determiner section for determining a gas fuel instrument which is connected to the fluid passage, using the slope of the change in the gas fuel flow rate in the first measurement period and the slope of the change in the gas fuel flow rate in the second measurement period.

A fuel instrument determination method of the present invention, comprises obtaining a slope of a change in a fuel flow rate in a first measurement period; obtaining a slope of a change in the fuel flow rate in a second measurement period which is different in length from the first measurement period; and determining a fuel instrument, using the slope of the change in the fuel flow rate in the first measurement period and the slope of the change in the fuel flow rate in the second measurement period.

In the above fuel instrument determination method, the second measurement period may be composed of a plurality of first measurement periods.

In the above fuel instrument determination method, in the determination, the fuel instrument may be determined, using each of slopes of changes in fuel flow rates in the plurality of first measurement periods and the slope of the change in the fuel flow rate in the second measurement period.

In the above fuel instrument determination method, the second measurement period may include the plurality of first measurement periods which are successive.

In the above fuel instrument determination method, in the determination, the fuel instrument may be determined depending on whether or not the slope of the change in the fuel flow rate in the first measurement period falls within a first range.

In the above fuel instrument determination method, in the determination, the fuel instrument may be determined depending on whether or not the slope of the change in the fuel flow rate in the second measurement period falls within a second range.

In the above fuel instrument determination method, in the determination, the fuel instrument may be determined depending on whether or not the slope of the change in the fuel flow rate in the first measurement period falls within a first range, and whether or not the slope of the change in the fuel flow rate in the second measurement period falls within a second range.

In the above fuel instrument determination method, the first range may include the second range.

In the above fuel instrument determination method, the determiner section may be configured to determine the fuel instrument, depending on whether or not slopes of changes in fuel flow rates in all of the first measurement periods included in the second measurement period fall within the first range.

In the above fuel instrument determination method, the first measurement periods may be equal in length to each other.

### Advantageous Effects of Invention

A fuel instrument determination device and a fuel instrument determination method of the present invention have advantages that it is possible to improve an accuracy of determination as to a fuel instrument, in a fuel instrument determination device and a fuel instrument determination method, which determine the fuel instrument by utilizing a slope of a change in a fuel flow rate.

### BRIEF DESCRIPTION OF THE DRAWINGS

FIG. 1 is a conceptual view showing an exemplary schematic configuration of a fuel instrument determination device according to Embodiment 1.

FIG. 2 is a block diagram showing an exemplary hardware configuration of the fuel instrument determination device according to Embodiment 1.

FIG. 3 is a flowchart showing an exemplary fuel instrument determination method according to Embodiment 1.

FIG. 4 is a view for explaining a concept of the fuel instrument determination method according to Embodiment 1.

FIG. 5 is a conceptual view showing an exemplary schematic configuration of a fuel instrument determination device according to Embodiment 2.

FIG. 6 is a flowchart showing an exemplary fuel instrument determination method according to Embodiment 2.

FIG. 7 is a flowchart showing an exemplary fuel instrument determination method according to a modified example of Embodiment 2.

FIG. 8 is a conceptual view showing an exemplary schematic configuration of a fuel instrument determination device according to Embodiment 3.

### DETAILED DESCRIPTION OF THE PREFERRED EMBODIMENTS

### Embodiment 1

### Device Configuration

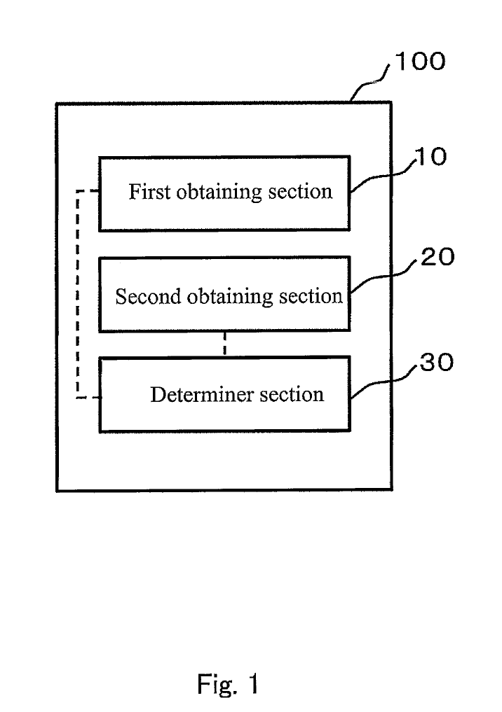

FIG. 1 is a conceptual view showing an exemplary schematic configuration of a fuel instrument determination device according to Embodiment 1.

As shown in FIG. 1, a fuel instrument determination device 100 according to Embodiment 1 includes a first obtaining section 10, a second obtaining section 20, and a determiner section 30. Although in the example of FIG. 1, the first obtaining section 10 and the second obtaining section 20 are communicatively coupled to the determiner section 30, a connection relationship is not limited to this.

The first obtaining section 10 obtains a slope of a change in a fuel flow rate in a first measurement period.

The second obtaining section 20 obtains a slope of a change in a fuel flow rate in a second measurement period which is different in length from first the measurement period.

The term “fuel flow rate” refers to an amount of a fuel such as a gas or liquid which flows per unit time. A unit of the flow rate is arbitrary, and may be, for example, sccm, liter/min, a gram/sec, etc. The flow rate may be a flow rate of, for example, a fuel gas, kerosene, etc. The flow rate is preferably a flow rate of the fuel gas such as a natural gas, or LPG.

The term “slope of a change in a fuel flow rate” may be value expressed as (q2−q1)/(t2−t1) when the flow rate at time t1 is q1, the flow rate at time t2 is t2, and a measurement period is a period from the time t1 to the time t2. A unit of the time and a unit of the flow rate are arbitrary. The term “slope of a change in a fuel flow rate” includes a parameter substantially representing the slope in addition to the above. The term “slope of a change in a fuel flow rate” may be, for example, a change in a flow rate per unit time. For example, in a case where a plurality of first measurement periods are equal in length to each other, a difference in flow rate may be used as “slope of a change in a fuel flow rate”.

The first measurement period may be, for example, about several seconds. The second measurement period may be, for example, about several tens seconds. The second measurement period is preferably longer than the first measurement period. The second measurement period preferably includes the plurality of first measurement periods. More preferably, the second measurement period is composed of the plurality of first measurement periods which are successive.

A method of obtaining the slope of the change in the fuel flow rate in the first measurement period by the first obtaining section 10 is not particularly limited. Specifically, for example, the first obtaining section 10 may receive the slope of the change in the fuel flow rate from an outside device via communication, and the like. Or, the fuel instrument determination device 100 may include a flow meter and a timer and the first obtaining section 10 may calculate the slope of the change in the fuel flow rate based on a correspondence between the flow rate received from the flow meter and time received from the timer.

A method of obtaining the slope of the change in the fuel flow rate in the second measurement period by the second obtaining section 20 is not particularly limited. Specifically, for example, the second obtaining section 20 may receive the slope of the change in the fuel flow rate from the outside device via communication, and the like. Or, the fuel instrument determination device 100 may include the flow meter and the timer and the second obtaining section 20 may calculate the slope of the change in the fuel flow rate based on a correspondence between the flow rate received from the flow meter and time received from the timer. Or, the second obtaining section 20 may calculate the slope of the change in the fuel flow rate in the second measurement period using the slope of the change in the fuel flow rate in the first measurement period which is obtained by the first obtaining section 10.

The determiner section 30 determines a fuel instrument using the slope of the change in the fuel flow rate in the first measurement period and the slope of the change in the fuel flow rate in the second measurement period.

The term “fuel instrument” refers to a fuel instrument which is a determination target for which the fuel instrument determination device performs determination, and for example, a fuel gas instrument, etc., which is connected to a pipe which is supplied with a fuel gas from a fuel gas utility company in a building equipped with the fuel instrument determination device.

The phrase “determines a fuel instrument” is meant to include identifying a type of a fuel instrument, the use of which has been started, identifying a type of a fuel instrument, the use of which has been finished, identifying a type of a fuel instrument in use, identifying a type of a fuel instrument which is not in use, etc.

A specific determination method of the fuel instrument is not particularly limited. For example, in a case where a degree (variance) of non-uniformity of the slopes of the changes in the fuel flow rates in the plurality of first measurement periods is less than a first threshold and the slope of the change in the fuel flow rate in the second measurement period falls within a second range, it may be determined that a particular fuel instrument is in use (or is not in use). Or, in a case where all of the slopes of the changes in the fuel flow rates in the plurality of first measurement periods fall within the first range and all of the slopes of the changes in the fuel flow rates in the plurality of second measurement periods fall within the second range, it may be determined that a particular fuel instrument is in use (or is not in use). Whether or not the first range includes an upper limit threshold and whether or not the first range includes a lower limit threshold may be set as desired. Whether or not the second range includes an upper limit threshold and whether or not the second range includes a lower limit threshold may be set as desired. Any determination method may be used so long as the slope of the change in the fuel flow rate in the first measurement period and the slope of the change in the fuel flow rate in the second measurement period are used.

The number of the first measurement periods used in the determination may be set as desired. The number of the second measurement periods used in the determination may be set as desired.

The determiner section 30 preferably determines the fuel instrument using each of the slopes of the changes in the fuel flow rates in the plurality of first measurement periods and the slope of the change in the fuel flow rate in the second measurement period.

The determiner section 30 more preferably determines the fuel instrument based on whether or not the slope of the change in the fuel flow rate in the first measurement period falls within the first range. The determiner section 30 more preferably determines the fuel instrument based on whether or not the slope of the change in the fuel flow rate in the second measurement period falls within the second range. The determiner section 30 more preferably determines the fuel instrument based on whether or not the slope of the change in the fuel flow rate in the first measurement period falls within the first range, and whether the slope of the change in the fuel flow rate in the second measurement period falls within the second range. The first range more preferably includes the second range.

The determiner section 30 more preferably determines the fuel instrument based on whether or not the slopes of the changes in the fuel flow rates in all of the first measurement periods included in the second measurement period fall within the first range.

The first measurement periods are preferably equal in length to each other.

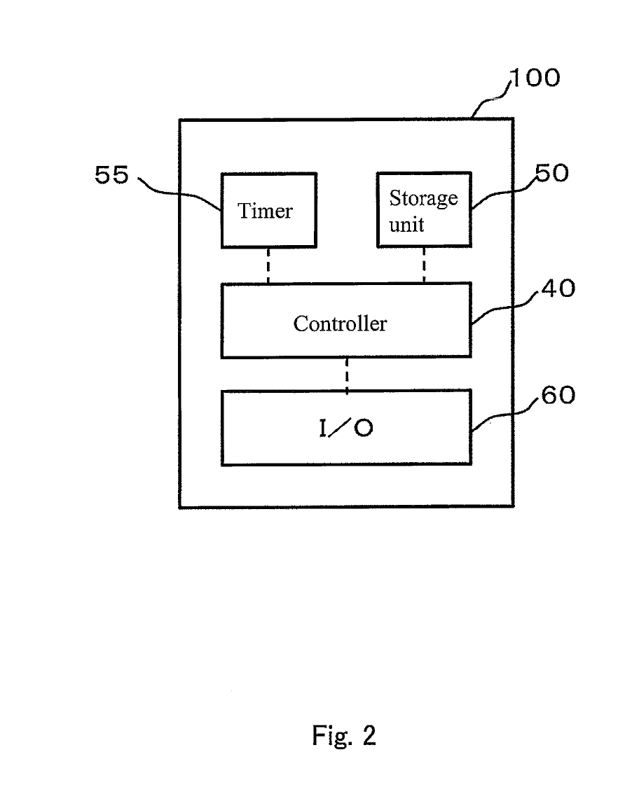

FIG. 2 is a block diagram showing an exemplary hardware configuration of the fuel instrument determination device according to Embodiment 1.

As exemplarily shown in FIG. 2, the fuel instrument determination device 100 includes, for example, a controller 40, a storage unit 50, a timer 55, and an input/output unit 60. Although in the example of FIG. 2, the timer 55, the storage unit 50, and the input/output unit 60 are communicatively coupled to the controller 40, a connection relationship is not limited to this.

The controller 40 is not particularly limited so long as it has a control function, and may be, for example, MPU, CPU, etc. The controller 40 may be constituted by a single controller which performs centralized control or may be a plurality of controllers which cooperate with each other to perform distributed control.

The storage unit 50 contains, for example, a program used for calculating the slope of the change in the fuel flow rate, a determination program, etc., which are executed by the controller 40. The storage unit 50 may be, for example, a memory.

The timer 55 is not particularly limited so long as it has a time measuring function, and may be, for example, a clock circuit, etc.

The input/output unit 60 is a unit via which the controller 40 and another section or outside device perform communication with each other. The input/output unit 60 may be connected to a flow meter included in the fuel instrument determination device 100. The input/output unit 60 may be connected to a flow meter device outside of the fuel instrument determination device 100 via a network.

For example, the first obtaining section 10 may be implemented by the controller 40, the storage unit 50, the timer 55, and the input/output unit 60. Also, for example, the second obtaining section 20 may be implemented by the controller 40, the storage unit 50, the timer 55, and the input/output unit 60. Also, for example, the determiner section 30 may be implemented by the controller 40, the storage unit 50, and the input/output unit 60.

[Fuel Instrument Determination Method]

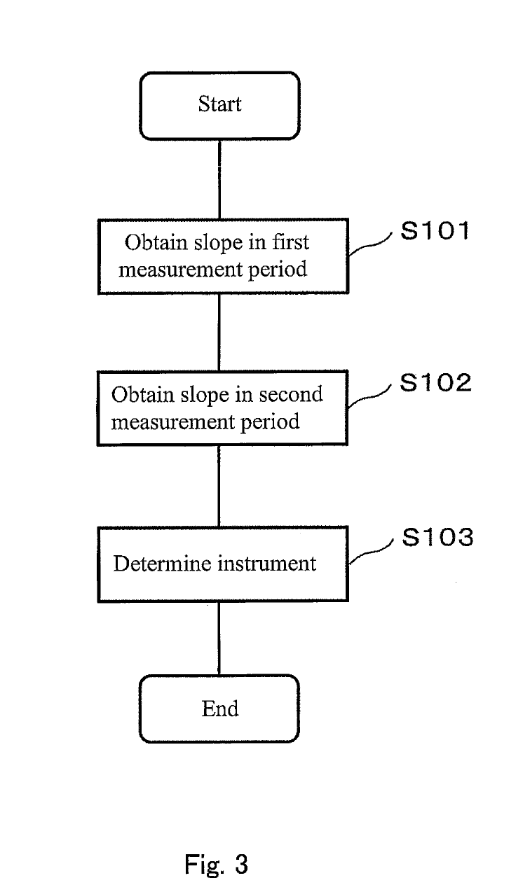

FIG. 3 is a flowchart showing an exemplary fuel instrument determination method according to Embodiment 1. Hereinafter, with reference to FIG. 3, the operation method of the fuel instrument determination device 100 according to Embodiment 1 and the fuel instrument determination method according to Embodiment 1 will be described. It is supposed that in the operation of the fuel instrument determination device 100, for example, each operation may be executed under control of the controller 40 based on the operation program stored in the storage unit 50.

When the fuel instrument determination operation starts (Start), initially, the slope of the change in the fuel flow rate in the first measurement period is obtained (step S101).

In the fuel instrument determination device 100, the first obtaining section 10 performs step S101. The first obtaining section 10 sends the slope of the change in the fuel flow rate in the first measurement period to the determiner section 30.

The operation performed by the first obtaining section 10 to obtain the slope of the change in the fuel flow rate in the first measurement period is implemented as follows, for example, in the hardware exemplarily shown in FIG. 2. Firstly, the controller 40 obtains a fuel flow rate value (first flow rate value) via the input/output unit 60, and stores in the storage unit 50, the first flow rate value, along with clock information (first clock) obtained from the timer 55. Then, when the clock information obtained from the timer 55 indicates that the first measurement period has passed, the controller 40 obtains a fuel flow rate value (second flow rate value) again via the input/output unit 60, and stores in the storage unit 50, the second flow rate value, along with clock information (second clock) obtained from the timer 55. After that, the controller 40 calculates the slope of the change in the fuel flow rate in the first measurement period by dividing a difference between the first flow rate value and the second flow rate value by a difference (first measurement period) between the first clock and the second clock. The slope is stored in the storage unit 50 in correspondence with, for example, the first clock.

Then, the slope of the change in the fuel flow rate in the second measurement period which is different in length from the first measurement period is obtained (step S102).

In the fuel instrument determination device 100, the second obtaining section 20 performs step S102. The second obtaining section 20 sends the slope of the change in the fuel flow rate in the second measurement period to the determiner section 30.

The operation performed by the second obtaining section 20 to obtain the slope of the change in the fuel flow rate in the first measurement period is implemented as follows, for example, in the hardware exemplarily shown in FIG. 2. Firstly, the controller 40 obtains a flow rate value (third flow rate value) via the input/output unit 60, and stores in the storage unit 50, the third flow rate value, along with clock information (third clock) obtained from the timer 55. Then, when the clock information obtained from the timer 55 indicates that the second measurement period has passed, the controller 40 obtains a flow rate value (fourth flow rate value) again via the input/output unit 60, and stores in the storage unit 50, the fourth flow rate value, along with clock information (fourth clock) obtained from the timer 55. After that, the controller 40 calculates the slope of the change in the fuel flow rate in the second measurement period by dividing a difference between the third flow rate value and the fourth flow rate value by a difference (second measurement period) between the third clock and the fourth clock. The slope is stored in the storage unit 50 in correspondence with, for example, the third clock.

Then, the fuel instrument is determined using the slope of the change in the fuel flow rate in the first measurement period which is obtained in step S101 and the slope of the change in the fuel flow rate in the second measurement period which is obtained in step S102 (step S103), and the fuel instrument determination operation is terminated (End).

In the fuel instrument determination device 100, the determiner section 30 performs step S103.

The operation performed by the determiner section 30 to determine the fuel instrument is implemented as follows, for example, in the hardware exemplarily shown in FIG. 2. Specifically, the controller 40 determines the fuel instrument, using the slope of the change in the fuel flow rate in the first measurement period which is stored in the storage unit 50, the slope of the change in the fuel flow rate in the second measurement period which is stored in the storage unit 50, and the determination program stored in the storage unit 50.

How a result of the determination is processed is not limited. For example, the result of the determination may be output from an output means such as a display and a printer, or may be sent to a data center, etc., via a network.

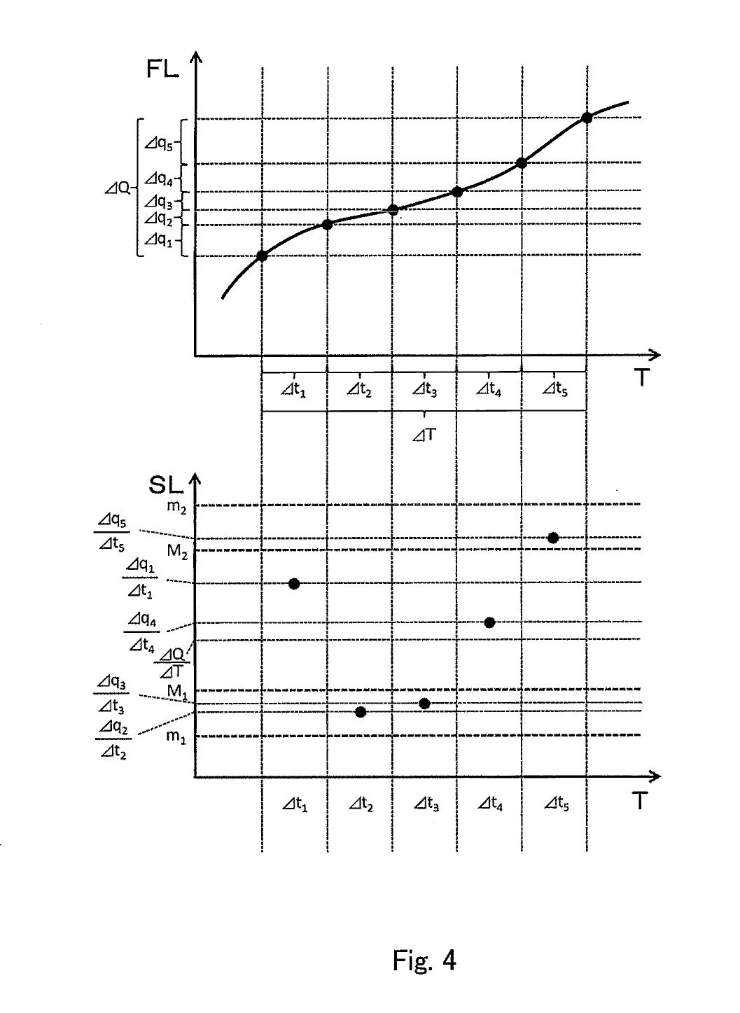

FIG. 4 is a view for explaining a concept of the fuel instrument determination method according to Embodiment 1. An upper half part of FIG. 4 is a graph showing an example of the change in the fuel flow rate which occurs with time. In this graph, a horizontal axis indicates time T and a vertical axis indicates the flow rate FL. A lower half part of FIG. 4 is a graph showing an example of the slope of the change in the fuel flow rate. In this graph, a horizontal axis indicates time T and a vertical axis indicates the slope SL of the change in the fuel flow rate. Hereinafter, a specific fuel instrument determination method according to the present embodiment will be described with reference to FIG. 4. Hereinafter, an example of the fuel instrument determination will be described assuming that a fuel cell system is a determination target.

Δtᵢ (i=1 to 5) indicates i-th first measurement period. In the example of FIG. 4, Δt1 to Δt5 are equal in length to each other. However, Δt1 to Δt5 may be different in length from each other. Δqᵢ (i=1 to 5) indicates the change in the fuel flow rate in the i-th first measurement period. The slope of the change in the fuel flow rate in the i-th first measurement period is expressed as Δqᵢ/Δtᵢ (i=1 to 5).

ΔT indicates the second measurement period. In the example of FIG. 4, the second measurement period is composed of five successive first measurement periods. In other words, ΔT=ΣΔtᵢ (i=1 to 5). ΔQ indicates the change in the fuel flow rate in the second measurement period. In the example of FIG. 4, ΔQ=ΣΔqᵢ (i=1 to 5). Therefore, the slope of the change in the fuel flow rate in the second measurement period is expressed as ΔQ/ΔT.

The determination as to the fuel instrument is performed based on, for example, whether or not all of the slopes Δqᵢ/Δtᵢ (i=1 to 5) of the changes in the fuel flow rates in the first measurement periods are equal to or greater than m₁ and equal to or less than m₂, and whether or not the slope ΔQ/ΔT of the change in the fuel flow rate in the second measurement period is equal to or greater than M₁ and equal to or less than M₂.

For example, as exemplarily shown in FIG. 4, when m₁, m₂, M₁, and M₂ are positive values, all of the slopes Δqᵢ/Δtᵢ are equal to or greater than m₁ and equal to or less than m₂, and ΔQ/ΔT is equal to or greater than M₁ and equal to or less than M₂, it can be seen that the flow rate increases gradually with a constant slope. From this, it can be determined that the fuel cell system is in operation.

In the same manner, for example, when m₁, m₂, M₁, and M₂ are negative values, all of the slopes Δqᵢ/Δtᵢ are equal to or greater than m₁ and equal to or less than m₂, and ΔQ/ΔT is equal to or greater than M₁ and equal to or less than M₂, it can be seen that the flow rate decreases gradually with a constant slope. From this, it can be determined that the fuel cell system is in operation.

It should be noted that signs of m₁, m₂, M₁, and M₂ may not necessarily be the same. Although in the above description, ranges to be satisfied by the slopes contain m₁, m₂, M₁, and M₂ which are thresholds, these ranges may not contain the thresholds.

In accordance with the method as described above, it becomes possible to accurately determine the fuel instrument which causes a rapid change in the fuel flow rate and the fuel cell system which causes a gradual change in the fuel flow rate such that the fuel instrument and the fuel cell system are distinguished from each other.

The condition of the slope of the change in the fuel flow rate in the first measurement period may not necessarily be the same as the condition of the slope of the change in the fuel flow rate in the second measurement period. Especially, in a case where the first measurement period is as short as several seconds, a slope which is deviated considerably from its original gradual slope, may be sometimes obtained as the slope, due to an influence of a measurement error and the like of the flow rate. In this case, to avoid misdetermination, the condition of the slope of the change in the fuel flow rate in the first measurement period is preferably smaller than the condition of the slope of the change in the fuel flow rate in the second measurement period. Specifically, when the first range is defined as the range in which the slope is equal to or greater than m₁ and equal to or less than m₂, and the second range is defined as the range in which the slope is equal to or greater than M₁ and equal to or less than M₂, the first range preferably includes the second range. Specifically, for example, when the condition of the slope of the change in the fuel flow rate in the first measurement period is equal to or greater than m₁ and equal to or less than m₂, and the condition of the slope of the change in the fuel flow rate in the second measurement period is equal to or greater than M₁ and equal to or less than M₂, m₁≦M₁<M₂≦m₂ is preferably satisfied. Or, M₁≦m₁<M₂≦m₂ may be satisfied. Or, M₁≦m₁<m₂≦M₂ may be satisfied. Or, m₁≦M₁<m₂≦M₂ may be satisfied.

In a case where there are a plurality of first measurement periods, the condition in which the slopes in all of the first measurement periods fall within an allowable range may not be used. For example, the condition in which the slope(s) of the first determination period(s) which is/are randomly selected fall(s) within the allowable range may be used. Or, the condition in which the slopes in all of the first determination periods with odd ordinal numbers fall within the allowable range may be used. The value of the slope may not be necessarily directly compared to the threshold. It may be determined whether or not the slope of the change in the fuel flow rate in the first measurement period satisfies a predetermined condition using an indicator indicating a degree to which the value of the slope is varied among the plurality of first measurement periods, such as a variance, a standard deviation, or a value obtained by dividing the variance or the standard deviation by the corresponding mean value. A specific determination method is not limited so long as the determination is performed using the slope of the change in the fuel flow rate in the first measurement period.

In a case where there are a plurality of second measurement periods, the condition in which the slopes in all of the second measurement periods fall within an allowable range may not be used. For example, the condition in which the slope(s) of the second determination period(s) which is/are randomly selected fall(s) within the allowable range may be used. Or, the condition in which the slopes in all of the second determination periods with odd ordinal numbers fall within the allowable range may be used. The value of the slope may not be necessarily directly compared to the threshold. It may be determined whether or not the slope of the change in the fuel flow rate in the second measurement period satisfies a predetermined condition using an indicator indicating a degree to which the value of the slope is varied among the plurality of second measurement periods, such as a variance, a standard deviation, or a value obtained by dividing the variance or the standard deviation by the corresponding mean value. A specific determination method is not limited so long as the determination is performed using the slope of the change in the fuel flow rate in the second measurement period.

The condition of the slope of the change in the fuel flow rate in the first measurement period may be different qualitatively from the condition of the slope of the change in the fuel flow rate in the second measurement period. Specifically, for example, regarding the slope of the change in the fuel flow rate in the first measurement period, the condition may be whether or not the value derived by dividing the standard deviation by the mean value is equal to or less than a predetermined threshold. Regarding the slope of the change in the fuel flow rate in the second measurement period, the condition may be whether or not the slope falls within the second range. Regarding the slope of the change in the fuel flow rate in the first measurement period, the condition may be whether or not the slope falls within the first range, while regarding the slope of the change in the fuel flow rate in the second measurement period, another condition may be used, instead of whether or not the slope falls within the second range.

### Embodiment 2

### Device Configuration

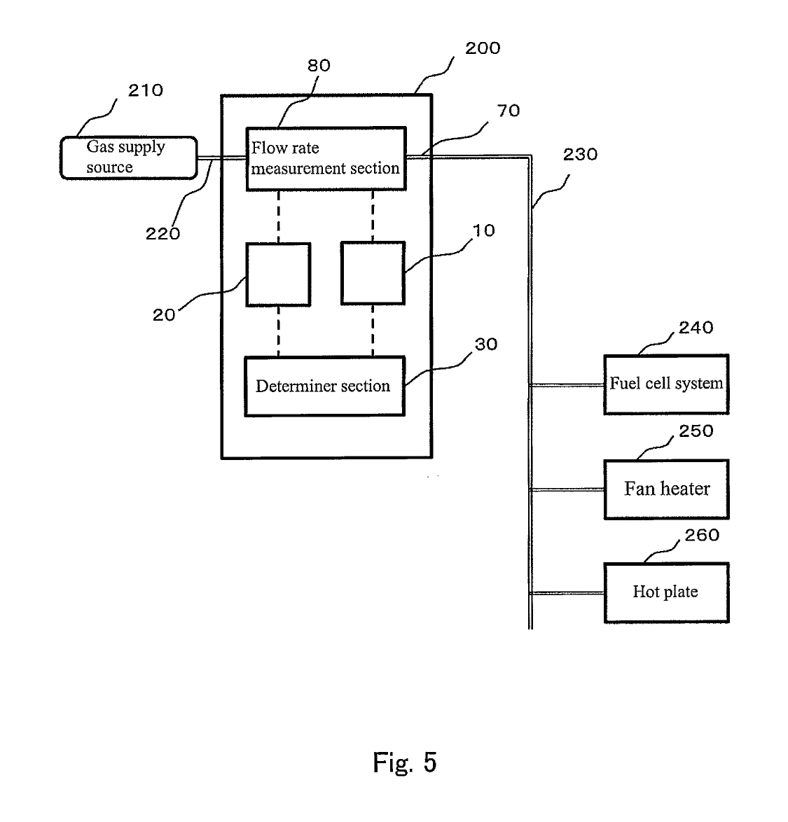

FIG. 5 is a conceptual view showing an exemplary schematic configuration of a fuel instrument determination device according to Embodiment 2.

As shown in FIG. 5, a fuel instrument determination device 200 according to Embodiment 2 includes the first obtaining section 10, the second obtaining section 20, the determiner section 30, a fluid passage 70, and a flow rate measurement section 80. Although in the example of FIG. 5, the first obtaining section 10 and the second obtaining section 20 are communicatively coupled to the determiner section 30 and the flow rate measurement section 80, a connection relationship is not limited to this.

The flow rate measurement section 80 measures a flow rate of a fuel flowing through the fluid passage 70. As the flow rate measurement section 80, for example, an ultrasonic flow meter, a flow meter of a flow sensor type, etc., may be used. In a case where the hardware configuration of FIG. 2 is employed, the flow rate measurement section 80 may be a flow sensor which may be connected to the input/output unit 60.

The fluid passage 70 is connected to a gas supply source 210 via an upstream gas pipe 220. The gas supply source 210 may be, for example, a gas supply pipe of a gas utility company. The fluid passage 70 is connected to gas instruments such as a fuel cell system 240, a fan heater 250 and a hot plate 260, via a downstream gas pipe 230.

In the present embodiment, the first obtaining section 10 obtains the slope of the change in the fuel flow rate in the first measurement period based on the fuel flow rate measured by the flow rate measurement section 80. The second obtaining section 20 obtains the slope of the change in the fuel flow rate in the second measurement period which is different in length from the first measurement section, based on the fuel flow rate measured by the flow rate measurement section 80.

In the present embodiment, the constituents of the device, which are other than the above, may be the same as those of Embodiment 1. Therefore, the same constituents are designated by the same reference symbols and names, and will not be described in detail repetitively.

Although FIG. 5 exemplarily shows a case where the fuel is the gas, the fuel may be a liquid fuel such as kerosene.

[Fuel Instrument Determination Method]

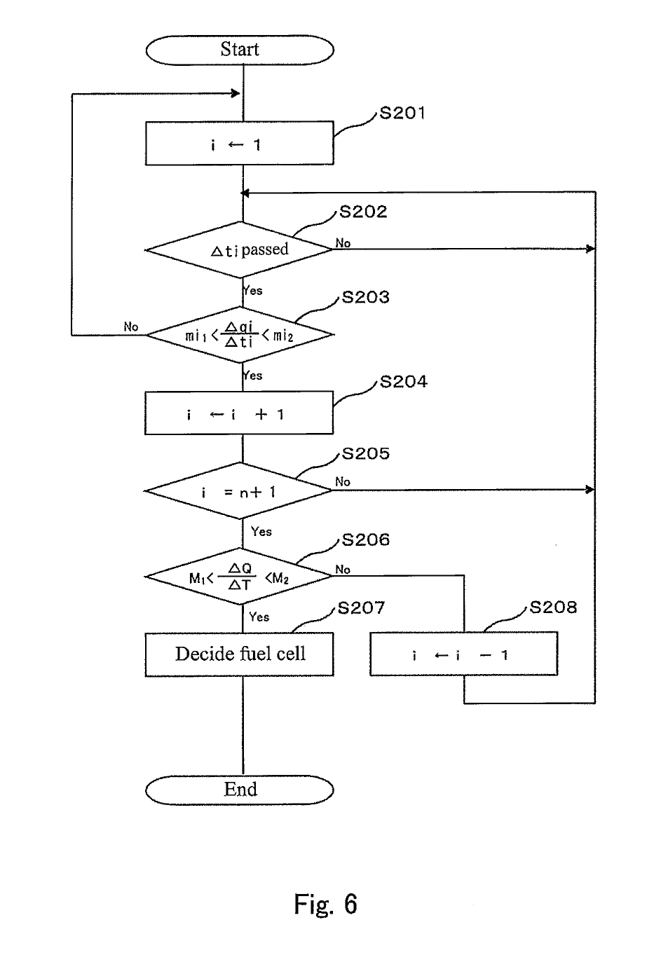

FIG. 6 is a flowchart showing an exemplary fuel instrument determination method according to Embodiment 2. Hereinafter, with reference to FIG. 6, the operation method of the fuel instrument determination device 200 according to Embodiment 2 and the fuel instrument determination method according to Embodiment 2 will be described. It is supposed that in the operation of the fuel instrument determination device 200, for example, each operation may be executed under control of the controller 40 based on an operation program stored in the storage unit 50. Although a case where the example of FIG. 4 is used will be exemplarily described, the present embodiment is not limited to this configuration, as a matter of course.

When the fuel instrument determination operation starts (Start), initially, 1 is stored in a variable i (step S201). At a time point when Δtᵢ has passed (Yes in step S202), the slope Δqᵢ/Δtᵢ in the change in the fuel flow rate in the i-th first measurement period is calculated. It is determined whether or not mᵢ₁<(Δqᵢ/Δtᵢ)<mᵢ₂ is satisfied (step S203). mᵢ₁ indicates a lower limit of the slope of the change in the fuel flow rate in the i-th first measurement period. mᵢ₂ indicates an upper limit of the slope of the change in the fuel flow rate in the i-th first measurement period. When a result of the determination in step S203 is No, the process returns to step S201.

When a result of the determination in step S203 is Yes, a value which is a sum of 1 and the variable i is stored in the variable i (step S204). It is determined whether or not i=n+1 is satisfied (step S205). n indicates the number of first measurement periods included in the second measurement period. When a result of the determination in step S205 is No, the process returns to step S202.

When a result of the determination in step S205 is Yes, the slope ΔQ/Δ T of the change in the fuel flow rate in the second measurement period is calculated. It is determined whether or not M₁<(ΔQ/Δ T)<M₂ is satisfied (step S206).

When a result of the determination in step S206 is Yes, it is determined that the fuel cell system is in use (step S207), and the fuel instrument determination operation is terminated (End).

When a result of the determination in step S206 is No, a value obtained by subtracting 1 from the variable i is stored in the variable i (step S208), and the process returns to step S202.

The above described operation and method are merely exemplary. In the present embodiment, the operation method, the calculation method, etc., may be the same as those of Embodiment 1.

### Modified Example

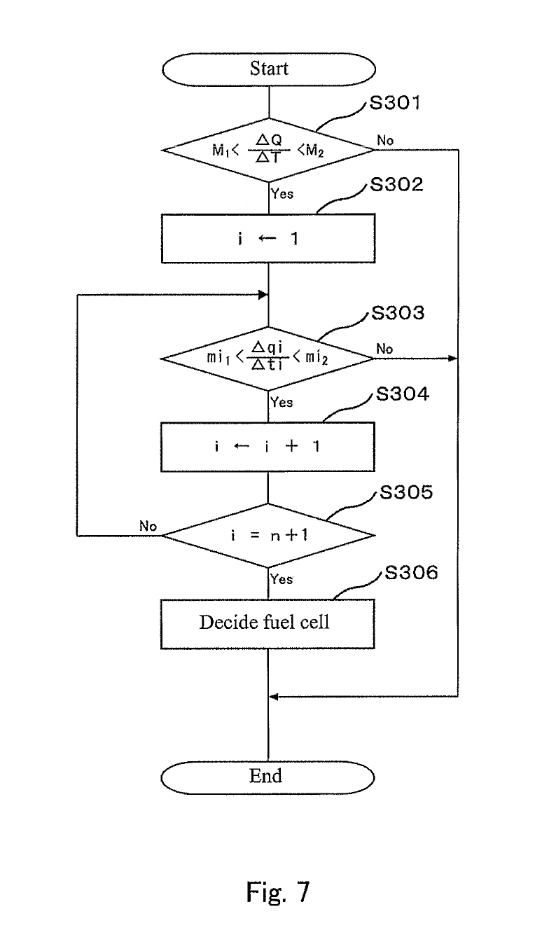

FIG. 7 is a flowchart showing an exemplary fuel instrument determination method according to a modified example of Embodiment 2. Hereinafter, with reference to FIG. 7, a description will be given of the operation method of the fuel instrument determination device according to the modified example of Embodiment 2 and the fuel instrument determination method according to the modified example of Embodiment 2. Since the fuel instrument determination device according to the modified example of Embodiment 2 may be identical in configuration to that of Embodiment 2, this will not be described in detail in repetition. It is supposed that in the operation of the fuel instrument determination device, for example, each operation may be executed under control of the controller 40 based on the operation program stored in the storage unit 50. Although a case where the example of FIG. 4 is used will be exemplarily described, the present modified example is not limited to this configuration, as a matter of course.

When the fuel instrument determination operation starts (Start), initially, the slopes Δqᵢ/Δtᵢ of the changes in the fuel flow rates in the plurality of first measurement periods, and the slope ΔQ/Δ T of the change in the fuel flow rate in the second measurement period are obtained. It is determined whether or not M₁<(ΔQ/Δ T)<M₂ is satisfied (step S301). That is, at a time point when step S301 is performed, the second measurement period has already passed. When a result of the determination in step S301 is No, the fuel instrument determination operation is terminated (End).

Then, 1 is stored in the variable i (step S302), and it is determined whether or not mᵢ₁<(Δqᵢ/Δtᵢ)<mᵢ₂ is satisfied (step S303). When a result of the determination in step S303 is No, the fuel instrument determination operation is terminated (End).

When a result of the determination in step S303 is Yes, a value which is a sum of 1 and the variable i is stored in the variable i (step S304). It is determined whether or not i=n+1 is satisfied (step S305). n indicates the number of first measurement periods included in the second measurement period. When a result of the determination in step S305 is No, the process returns to step S303.

When a result of the determination in step S305 is Yes, it is determined that the fuel cell system is in use (step S306), and the fuel instrument determination operation is terminated (End).

The above described operation and method are merely exemplary. In the present embodiment, the operation method, the calculation method, etc., may be the same as those of Embodiment 1.

### Embodiment 3

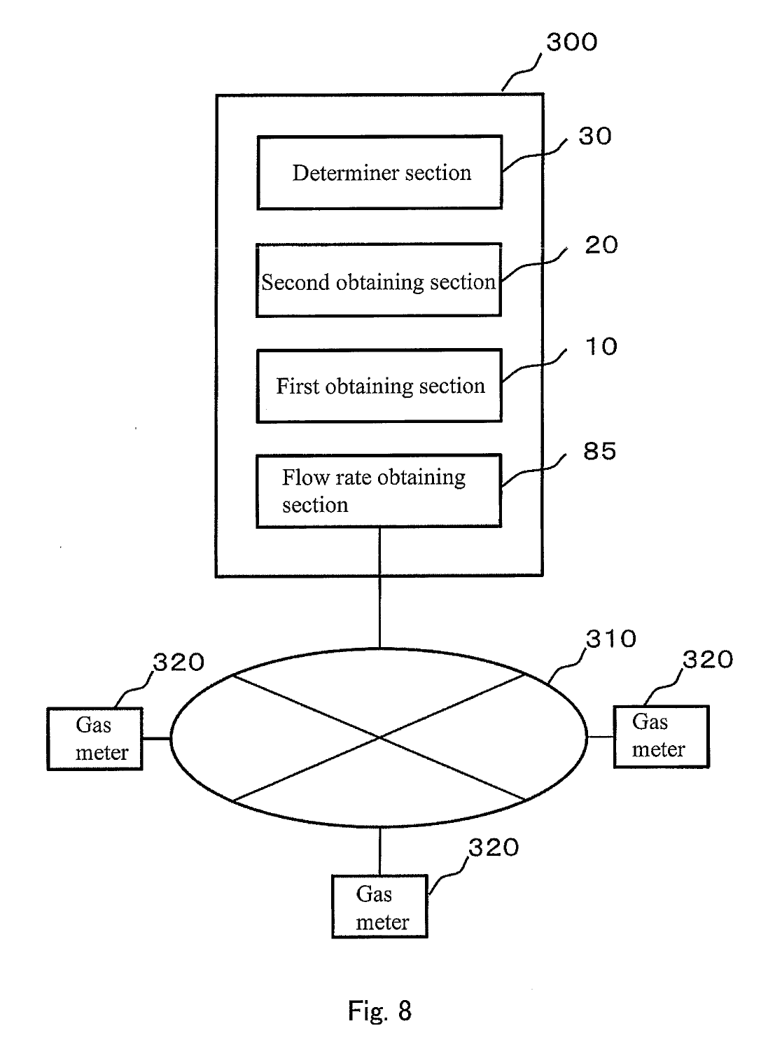

FIG. 8 is a conceptual view showing an exemplary schematic configuration of a fuel instrument determination device according to Embodiment 3.

As shown in FIG. 8, a fuel instrument determination device 300 according to Embodiment 3 includes the first obtaining section 10, the second obtaining section 20, the determiner section 30, and a flow rate obtaining section 85.

The flow rate obtaining section 85 obtains a gas flow rate from each of gas meters 320 via a network 310. In a case where the hardware configuration of FIG. 2 is used, the flow rate obtaining section 85 may be constituted by a communication board, etc., which may be connected to the input/output unit 60.

The network 310 may be a computer line such as LAN or internet, an analog phone line, an ISDN line, etc.

The gas meters 320 are gas meters installed at home, commercial stores (shops), etc., and are connected to the network 310. Each of the gas meters 320 sends a gas usage amount, i.e., gas flow rate of the gas used in the corresponding place, to the fuel instrument determination device 300 via the network 310.

The first obtaining section 10 is capable of obtaining a slope of a change in the gas fuel flow rate in the gas meter 320 in the first measurement period, based on the gas flow rate obtained by the flow rate obtaining section 85.

The second obtaining section 20 is capable of obtaining a slope of a change in the gas fuel flow rate in the gas meter 320 in the second measurement period, based on the gas flow rate obtained by the flow rate obtaining section 85.

In the present embodiment, the constituents of the device which are other than the above stated constituents may be the same as those of Embodiment 1. Therefore, in the present embodiment, the same constituents as those of Embodiment 1 are designated by the same reference symbols and names, and will not be described in detail. In addition, a specific determination method of the present embodiment may be the same as those of Embodiment 1 and Embodiment 2, and will not be described in detail in repetition.

It should be noted that the flow rate obtaining section 85 is not essential. The first obtaining section 10 may obtain from each of the gas meters 320 the slope of the change in the gas fuel flow rate in the gas meter 320 in the first measurement period, via the network 310. The second obtaining section 20 may obtain the slope of the change in the gas fuel flow rate in the gas meter 320 in the second measurement period, using the slope of the change in the gas fuel flow rate in the gas meter in the first measurement period, which is obtained by the first obtaining section 10.

In a further alternative, the first obtaining section 10 may obtain from each of the gas meters 320 the slope of the change in the gas fuel flow rate in the gas meter 320 in the first measurement period, via the network 310, and the second obtaining section 20 may obtain from each of the gas meters 320 the slope of the change in the gas fuel flow rate in the gas meter 320 in the second measurement period, via the network 310.

Numeral improvements and alternative embodiments of the present invention will be conceived by those skilled in the art in view of the foregoing description. Accordingly, the description is to be construed as illustrative only, and is provided for the purpose of teaching those skilled in the art the best mode of carrying out the invention. The details of the structure and/or function may be varied substantially without departing from the spirit of the invention.

### INDUSTRIAL APPLICABILITY

A fuel instrument determination device and a fuel instrument determination method of the present invention are useful as a fuel instrument determination device and a fuel instrument determination method, which can improve an accuracy of instrument determination.

### REFERENCE SIGNS LIST

10 first obtaining section
20 second obtaining section
30 determiner section
40 controller
50 storage unit
55 timer
60 input/output unit
70 fluid passage
80 flow rate measurement section
85 flow rate obtaining section
100 fuel instrument determination device
200 fuel instrument determination device
210 gas supply source
220 upstream gas pipe
230 downstream gas pipe
240 fuel cell system
250 fan heater
260 hot plate
300 fuel instrument determination device
310 network
320 gas meter

1. A fuel instrument determination device comprising:
a first obtaining section for obtaining a slope of a change in a fuel flow rate in a first measurement period;
a second obtaining section for obtaining a slope of a change in the fuel flow rate in a second measurement period which is different in length from the first measurement period; and
a determiner section for determining a fuel instrument, using the slope of the change in the fuel flow rate in the first measurement period and the slope of the change in the fuel flow rate in the second measurement period.

2. The fuel instrument determination device according to claim 1,
wherein the second measurement period includes a plurality of first measurement periods.

3. The fuel instrument determination device according to claim 2,
wherein the determiner section is configured to determine the fuel instrument, using each of slopes of changes in fuel flow rates in the plurality of first measurement periods and the slope of the change in the fuel flow rate in the second measurement period.

4. The fuel instrument determination device according to claim 2,
wherein the second measurement period is composed of the plurality of first measurement periods which are successive.

5. The fuel instrument determination device according to claim 4,
wherein the second obtaining section is configured to perform calculation to obtain the slope of the change in the fuel flow rate in the second measurement period, using the slope of the change in the fuel flow rate in the first measurement period, which is obtained by the first obtaining section.

6. The fuel instrument determination device according to claim 1,
wherein the determiner section is configured to determine the fuel instrument, depending on whether or not the slope of the change in the fuel flow rate in the first measurement period falls within a first range.

7. The fuel instrument determination device according to claim 1,
wherein the determiner section is configured to determine the fuel instrument, depending on whether or not the slope of the change in the fuel flow rate in the second measurement period falls within a second range.

8. The fuel instrument determination device according to claim 1,
wherein the determiner section is configured to determine the fuel instrument, depending on whether or not the slope of the change in the fuel flow rate in the first measurement period falls within a first range, and whether or not the slope of the change in the fuel flow rate in the second measurement period falls within a second range.

9. The fuel instrument determination device according to claim 8,
wherein the first range includes the second range.

10. The fuel instrument determination device according to claim 2,
wherein the determiner section is configured to determine the fuel instrument, depending on whether or not slopes of changes in fuel flow rates in all of the first measurement periods included in the second measurement period fall within the first range.

11. The fuel instrument determination device according to claim 1,
wherein the first measurement periods are equal in length to each other.

12. The fuel instrument determination device according to claim 1, comprising:
a flow rate obtaining section for obtaining a gas flow rate from a gas meter via a network;
wherein the first obtaining section is configured to obtain a slope of a change in a gas fuel flow rate in the gas meter in the first measurement period; and
wherein the second obtaining section is configured to obtain a slope of a change in the gas fuel flow rate in the gas meter in the second measurement period.

13. The fuel instrument determination device according to claim 1,
wherein the first obtaining section is configured to obtain from a gas meter a slope of a change in a gas fuel flow rate in the gas meter in the first measurement period via a network; and
wherein the second obtaining section is configured to perform calculation to obtain a slope of a change in the gas fuel flow rate in the gas meter in the second measurement period, using the slope of the change in the gas fuel flow rate in the gas meter in the first measurement period, which is obtained by the first obtaining section.

14. The fuel instrument determination device according to claim 1,
wherein the first obtaining section is configured to obtain from a gas meter a slope of a change in a gas fuel flow rate in the gas meter in the first measurement period via a network; and
wherein the second obtaining section is configured to obtain from the gas meter a slope of a change in the gas fuel flow rate in the gas meter in the second measurement period via the network.

15. A flow meter device comprising:
a fluid passage:
a flow rate measurement section for measuring a fuel flow rate of a fuel flowing through the fluid passage;
a first obtaining section for obtaining a slope of a change in the fuel flow rate in a first measurement period;
a second obtaining section for obtaining a slope of a change in the fuel flow rate in a second measurement period which is different in length from the first measurement period; and
a determiner section for determining a fuel instrument which is connected to the fluid passage, using the slope of the change in the fuel flow rate in the first measurement period and the slope of the change in the fuel flow rate in the second measurement period.

16. A gas meter comprising:
a fluid passage:
a flow rate measurement section for measuring a flow rate of a gas flowing through the fluid passage;
a first obtaining section for obtaining a slope of a change in a gas fuel flow rate in a first measurement period;
a second obtaining section for obtaining a slope of a change in the gas fuel flow rate in a second measurement period which is different in length from the first measurement period; and
a determiner section for determining a gas fuel instrument which is connected to the fluid passage, using the slope of the change in the gas fuel flow rate in the first measurement period and the slope of the change in the gas fuel flow rate in the second measurement period.

17. A fuel instrument determination method, comprising:
obtaining a slope of a change in a fuel flow rate in a first measurement period;
obtaining a slope of a change in the fuel flow rate in a second measurement period which is different in length from the first measurement period; and
determining a fuel instrument, using the slope of the change in the fuel flow rate in the first measurement period and the slope of the change in the fuel flow rate in the second measurement period.

18. The fuel instrument determination method, according to claim 17,
wherein the second measurement period includes a plurality of first measurement periods.

19. The fuel instrument determination method, according to claim 18,
wherein in the determination, the fuel instrument is determined, using each of slopes of changes in fuel flow rates in the plurality of first measurement periods and the slope of the change in the fuel flow rate in the second measurement period.

20. The fuel instrument determination method, according to claim 18,
wherein the second measurement period is composed of the plurality of first measurement periods which are successive.

21. The fuel instrument determination method, according to claim 17,
wherein in the determination, the fuel instrument is determined depending on whether or not the slope of the change in the fuel flow rate in the first measurement period falls within a first range.

22. The fuel instrument determination method, according to claim 17,
wherein in the determination, the fuel instrument is determined depending on whether or not the slope of the change in the fuel flow rate in the second measurement period falls within a second range.

23. The fuel instrument determination method, according to claim 17,
wherein in the determination, the fuel instrument is determined depending on whether or not the slope of the change in the fuel flow rate in the first measurement period falls within a first range, and whether or not the slope of the change in the fuel flow rate in the second measurement period falls within a second range.

24. The fuel instrument determination method, according to claim 23,
wherein the first range includes the second range.

25. The fuel instrument determination method, according to claim 17,
wherein the determiner section is configured to determine the fuel instrument, depending on whether or not slopes of changes in fuel flow rates in all of the first measurement periods included in the second measurement period fall within the first range.

26. The fuel instrument determination method, according to claim 17,
wherein the first measurement periods are equal in length to each other.
